(19) United States
(12) Patent Application Publication
(10) Pub. No.: US 2003/0093419 A1
(43) Pub. Date: May 15, 2003

(54) System and method for querying information using a flexible multi-modal interface

(76) Inventors: Srinivas Bangalore, Morristown, NJ (US); Michael Johnston, Hoboken, NJ (US); Marilyn A. Walker, Morristown, NJ (US); Stephen Whittaker, Morristown, NJ (US)

Correspondence Address: AT&T CORP., P.O. BOX 4110, MIDDLETOWN, NJ, 07748, US

(21) Appl. No.: 10/217,010

(22) Filed: Aug. 12, 2002

Related U.S. Application Data
(60) Provisional application No. 60/370,044, filed on Apr. 3, 2002.
(60) Provisional application No. 60/313,121, filed on Aug. 17, 2001.

(51) Int. Cl. G06F 7/00

(52) U.S. Cl. 707/3

(57) ABSTRACT

A system and method of providing information to a user via interaction with a computer device is disclosed. The computer device is capable of receiving user input via speech, pen or multi-modally. The device receives a user query regarding a business or other entity within an area such as a city. The user query is input in speech, pen or multi-modally. The computer device responds with information associated with the request using a map on the computer device screen. The device receives further user input in speech, pen or multi-modally, and presents a response to the user query. The multi-modal input can be any combination of speech, handwriting pen input and/or gesture pen input.

### PRIORITY APPLICATION

The present invention claims priority to provisional Patent Application No. 60/370,044, filed Apr. 3, 2002, the contents of which are incorporated herein by reference. The present invention claims priority to provisional Patent Application No. 60/313,121, filed Aug. 17, 2001, the contents of which are incorporated herein by reference.

### RELATED APPLICATIONS

The present application is related to Attorney Dockets 2001-0415, 2001-0415A, 2001-0415B, and 2001-0415C and Attorney Docket 2002-0054, filed on the same day as the present application, the contents of which are incorporated herein by reference.

### BACKGROUND OF THE INVENTION

1. Field of the Invention

The present invention relates to multi-modal interfaces and more specifically to a system and method of requesting information using a flexible multi-modal interface.

2. Discussion of Related Art

Systems for accessing information about local entities or businesses such as restaurants are not new. These informational systems can be accessed via the Internet or in some cases on handheld wireless devices. For example, many services are available on the Internet for accessing restaurant locations and information. These include www.citysearch.com and www.zagat.com. Another example can be found in the Yellow Pages section of www.mapquest.com. Most of these services help users obtain information surrounding a specific city or location. For example, a user who flies into Washington, D.C. may need information regarding restaurants, museums, tourist sites, etc. These information services combine directional instructions, business and restaurant reviews and maps to provide the user with the needed information. The system referred to is the information service that communicates data to the user either via the Internet or to a computer device.

As will be explained, these approaches are inefficient and complex in the required process of obtaining information. For example, with mapquest.com, in order to pull up a map and obtain directions to a restaurant, the user must first enter in an address. FIG. 1 illustrates a web page 10 associated with the mapquest.com website. Once the map comes up, a menu enables the user to select “restaurants” from a number of different features such as parks, museums, etc. The mapquest system then presents a listing of restaurants ranked according to distance from the address provided. Tabs enable the user to skip to an alphabetical listing or to a ratings and review information listing 14 for the restaurants. Assume the user selects a restaurant such as the District Chophouse on 509 7^{th} St. NW in Washington, D.C. The system presents reviews to the user with a selection button for driving directions 18. If the user selects driving directions, the system requests a starting point (rather than defaulting to the original address first input). Again, after the user inputs starting point directions into the system, the user must select “driving directions” 18 to obtain written directions to arrive at the restaurant.

Further, mapquest.com enables the user to select an “overview” tab 20 that will show a map with the restaurant listed. FIG. 1 illustrates the map 12 showing the location of the District Chophouse (16). The user must select the driving directions button 18 to input the user starting location and receive the driving directions. The mapquest service only enables the user to interact with the map by zooming in or re-centering the map using buttons 22.

Typical information services do not allow users dynamically to interact with a map to get information. Most of the inefficiencies relate to the numerous interactive steps necessary to navigate multiple menus to obtain the final directions or information desired. To further illustrate the complexity required by standard systems, the example of a user desiring directions to the District Chophouse is illustrated again in the context of a wireless handheld device.

An example of a system for accessing restaurant information on a mobile device is the Vindigo application. Vindigo is a Palm and Pocket PC application that provides restaurant and movie information for a number of cities. Again, like the web-based restaurant information guides, Vindigo does not allow users to interact directly with the map other than to pan and zoom. Vindigo uses maps but users must specify what they want to see on a different page. The interaction is considerably restrictive and potentially more confusing for the user.

To illustrate the steps required to obtain directions using the Vindigo service, assume a user in Washington D.C. is located at 11^{th} and New York Avenue and desires to find a restaurant. FIG. 2 illustrates first step required by the Vindigo system. A screen 20 indicates on a left column 22 a first cross street selectable by the user and a second column 24 provides another cross street. By finding or typing in the desired cross streets, the user can indicate his or her location to the Vindigo system. An input screen 26 is well known on handheld devices for inputting text. Other standard buttons such as OK 28 and Cancel 30 may be used for interacting with the system.

Once the user inputs a location, the user must select a menu that lists types of food. Vindigo presents a menu selection including food, bars, shops, services, movies, music and museums. Assume the user selects food. FIG. 3 illustrates the next menu presented. A column 32 within the screen 20 lists kinds of food such as African, Bagels, Bakery, Dinner, etc. Once a type of food is selected such as “Dinner”, the right column 34 lists the restaurants within that category. The user can sort by distance 36 from the user, name of restaurant, cost or rating. The system presents a sorting menu if the user selects button 36. Assume for this example that the user selects sort by distance.

The user then selects from the restaurant listing in column 34. For this example, assume the user selects the District Chophouse. The system presents the user with the address and phone number of the District Chophouse with tabs where the user can select a restaurant Review, a “Go” option that pulls up walking directions from the user's present location (11^{th} and New York Avenue) to the District Chophouse, a Map or Notes. The “Go” option includes a further menu where the user can select walking directions, a Metro Station near the user, and a Metro Station near the selected restaurant. The “Go” walking directions may be as follows:

Walking from New York Ave NW & 11^{th} Street NW, go South on 11^{th} St. NW. Go 9.25 miles

Turn left onto F. St. NW and go 0.25 miles.

Turn right onto 7^{th} St. NW and go 125 yards to the District Chophouse.

If the user selects a Metro Station near the user, the system presents the following:

Metro Center

Red Line, Orange Line, Blue Line

McPherson Square

Orange Line, Blue Line

Gallery-Pl—Chinatown

Red Line, Green Line, Yellow Line

When the user select a Metro Station near the District Chophouse, the system presents the following information regarding the Metro Stations:

Gallery Pl—Chinatown

Red Line, Green Line, Yellow Line

Archives-Navy Memorial

Green Line, Yellow Line

Metro Center

Red Line, Orange Line, Blue Line

If the user selects the Map tab, the system presents a map 40 as illustrated in FIG. 4. The location of the user 42 is shown at 11^{th} and New York Ave and the location of the District Chophouse 44 is shown at 7^{th} between E Street and F Street. The only interaction with the map allowed by the user is to reposition by resizing the map showing the user position and the restaurant position. No handwriting or gesture input can be received on the map. The above description illustrates several current methods by which users must interact with computer devices to exchange information with regards to map usage.

There are also spoken dialog systems for getting restaurant information, such as those hosted by Tell Me and other voice portals. These voice portals use speech recognition technology to understand and respond to user queries using structured dialogs. Such voice portals provide only the voice interaction for obtaining similar kinds of information such as directions to businesses, tourist sites, theaters such as movie theaters or other kinds of theaters, or other information. Voice portals lack the flexibility of the visual interface and do not have a map display.

Tellme provides a menu of categories that the user can hear, such as stock quotes, sports, travel, message center, and shopping. Following the example above, assume a caller desires directions from 1100 New York Avenue NW, Washington D.C. to the District Chophouse at 509 7^{th} St. NW. By calling Tellme to get directions, the following dialog must occur. This dialog starts when the main menu of options is spoken to the user (sports, travel, shopping, etc.):

User: Travel

Tellme: All right, travel . . . here are the choices, airlines, taxis, traffic, driving directions . . .

User: Driving directions

Tellme: Driving directions . . . let's get your starting location, tell me your city and state:

User: Washington D.C.

Tellme: OK, Washington D.C., . . . what street are you starting from?

User: New York Avenue North West

Tellme: New York Avenue, North West, tell me the address number

User: 1100

Tellme: 1100 New York Avenue North West, OK tell me the state of your destination.

User: Washington D.C.

Tellme: Washington D.C. . . . tell me the street of the destination.

User: 7^{th} Street North West

Tellme: 7^{th} Street North West, say the address number

User: 509

Tellme: 509 7th Street North West. Hang on while I get your directions. This trip will be about 7/10^{th} of a mile and will take about 2 minutes. The directions are in three steps. First, go east on New York Avenue North West and drive for 2/10 of a mile. Say next.

User: Next

Tellme: Step two. Take a slight right on K Street North West and drive 1/10 of a mile. Say next.

User: Next

Tellme: The last step is take a right on 7^{th} Street North West and go 4/10 of a mile. You should be at 509 7^{th} Street North West. That's the end.

As is illustrated above, obtaining the desired driving directions from a phone service such as Tellme or a web-based service such as Mapquest still requires numerous steps to adequately convey all the necessary information to receive information such as driving directions. In the above example, there are ten exchanges between the user and the system. The complexity of the user interface with the type of information services discussed above prevents their widespread acceptance. Most users do not have the patience or desire to negotiate and navigate such complex interfaces just to find directions or a restaurant review.

### SUMMARY OF THE INVENTION

What is needed in the art is an information service that simplifies the user interaction to obtain desired information from a computing device. The complexity of the information services described above is addressed by the present invention. An advantage of the present invention is its flexible user interface that combines speech, gesture recognition, handwriting recognition, multi-modal understanding, dynamic map display and dialog management.

Two advantages of the present invention include allowing users to access information via interacting with a map and a flexible user interface. The user interaction is not limited to speech only as in Tellme, or text input as in Mapquest or Vindigo. The present invention enables a combination of user inputs.

The present invention combines a number of different technologies to enable a flexible and efficient multi-modal user interface including dialogue management, automated determination of the route between two points, speech recognition, gesture recognition, handwriting recognition, and multi-modal understanding.

Embodiments of the invention include a system for interacting with a user, a method of interacting with a user, and a computer-readable medium storing computer instructions for controlling a computer device.

For example, an aspect of the invention relates to a method of providing information to a user via interaction with a computer device, the computer device being capable of receiving user input via speech, pen or multi-modally. The method comprises receiving a user query in speech, pen or multi-modally, presenting data to the user related to the user query, receiving a second user query associated with the presented data in one of the plurality of types of user input, and presenting a response to the user query or the second user query.

### BRIEF DESCRIPTION OF THE DRAWINGS

The foregoing advantages of the present invention will be apparent from the following detailed description of several embodiments of the invention with reference to the corresponding accompanying drawings, in which:

FIG. 1 illustrates a mapquest.com map locating a restaurant for a user;

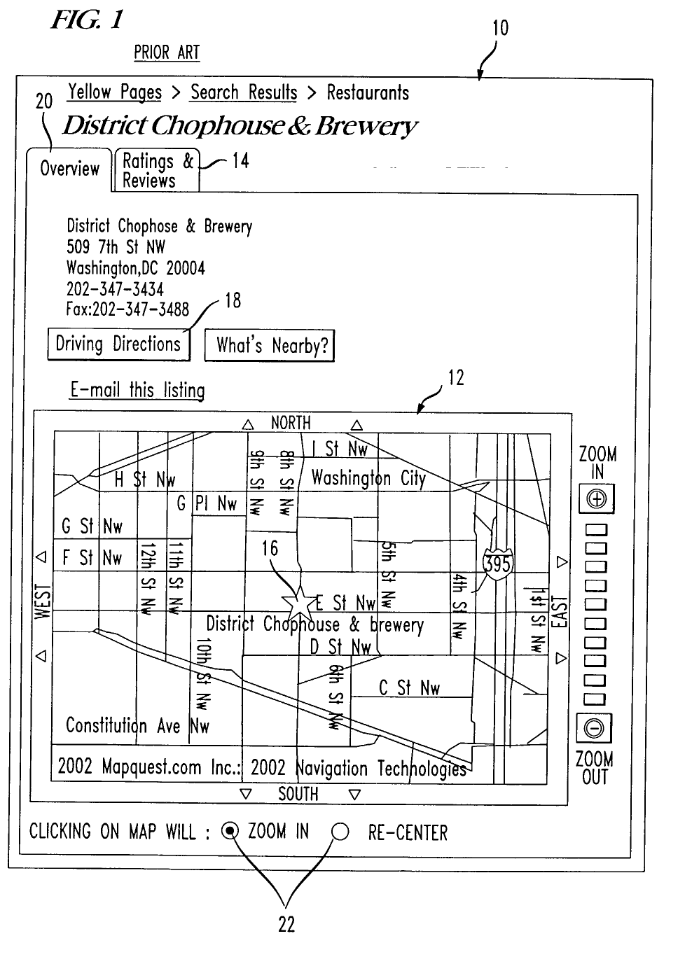

FIG. 2 illustrates a Vindigo palm screen for receiving user input regarding location;

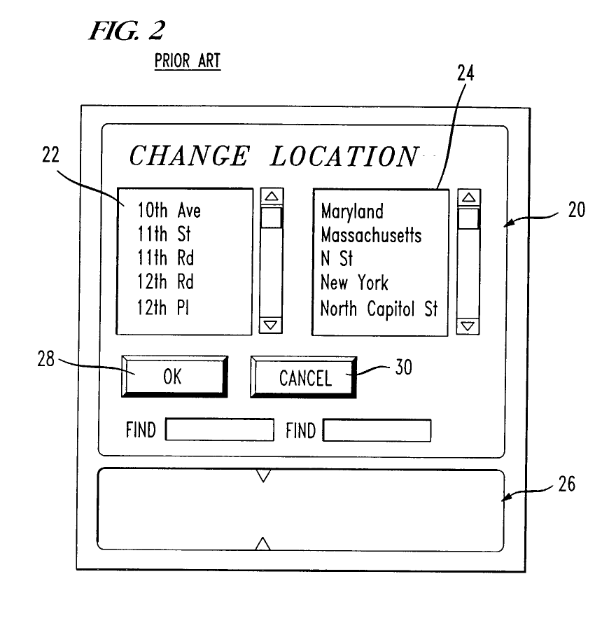

FIG. 3 illusrates a Vindigo palm screen for identifying a restuaruant;

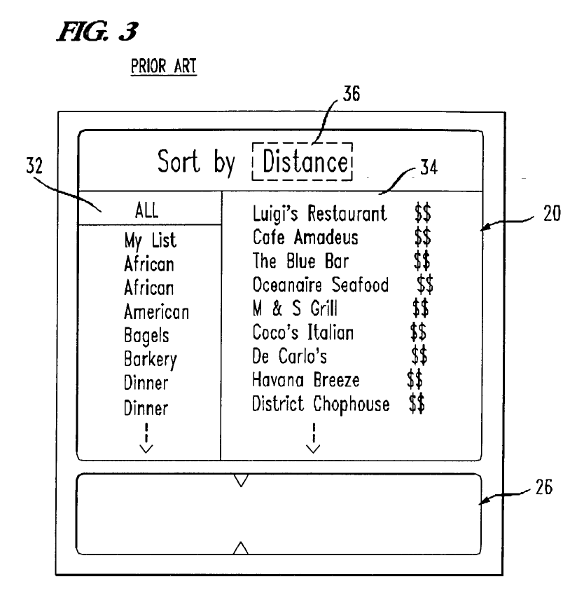

FIG. 4 shows a Vindigo palm screen map indicating the location of the user and a restaurant;

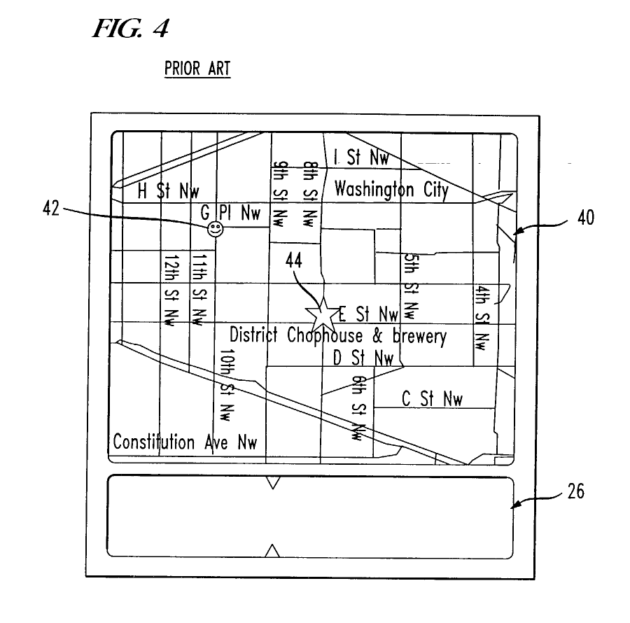

FIG. 5 shows an exemplary architecture according to an aspect of the present invention;

FIG. 6 shows an exemplary gesture lattice;

FIG. 7 shows an example flow diagram illustrating the flexibility of input according to an aspect of the present invention;

FIG. 8 illustrates the flexibility of user input according to an aspect of the present invention;

FIG. 9 illustrates further the flexibility of user input according to an aspect of the present invention; and

FIG. 10 illustrates the flexibility of responding to a user query and receiving further user input according to an aspect of the present invention.

### DETAILED DESCRIPTION OF THE INVENTION

According to the present invention, the style of interaction provided for accessing information about entities on a map is substantially more flexible and less moded than previous web-based, phone-based, and mobile device solutions. This invention integrates a number of different technologies to make a flexible user interface that simplifies and improves upon previous approaches.

The main features of the present invention include a map display interface and dialogue manager that are integrated with a multi-modal understanding system and pen input so that the user has an unprecedented degree of flexibility at each stage in the dialogue.

The system also provides a dynamic nature of the presentation of the information about entities or user inquiries. Mapquest, Vindigo and other pre-existing solutions provide lists of places and information. According to an aspect of the present invention, the user is shown a dynamic presentation of the information, where each piece of information such as a restaurant is highlighted in turn and coordinated with speech specifying the requested information.

Numerous advantages are experienced by the present invention, such as enabling the user to directly interact with a map on the screen rather than through a series of menus or a selection page, the non-moded and far less structured nature of the interaction and the dynamic multi-modal presentation of the information. These features will be described in more detail below.

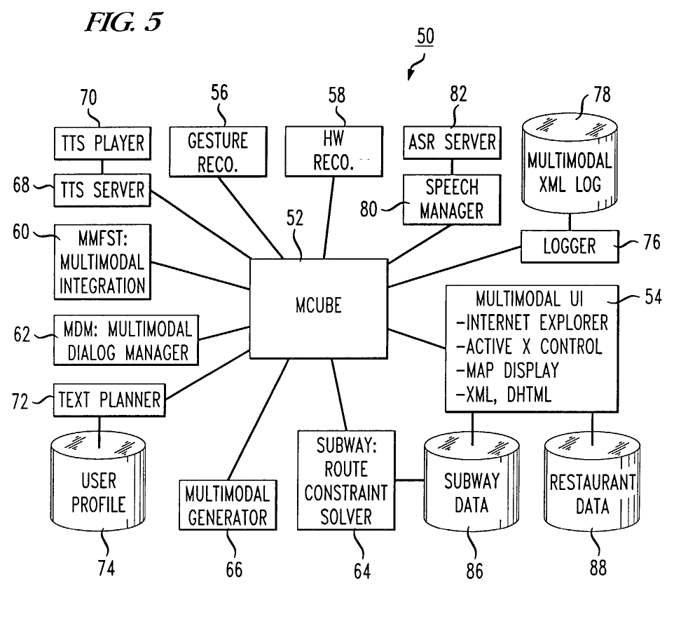

FIG. 5 illustrates the architecture for a computer device operating according to the principles of the present invention. The hardware may comprise a desktop device or a handheld device having a touch sensitive screen such as a Fujitsu Pen Tablet Stylistic-500 or 600. The processes that are controlled by the various modules according to the present invention may operate in a client/server environment across any kind of network such as a wireless network, packet network, the Internet, or an Internet Protocol Network. Accordingly, the particular hardware implementation or network arrangement is not critical to the operation of the invention, but rather the invention focuses on the particular interaction between the user and the computer device. The term “system” as used herein therefore means any of these computer devices operating according to the present invention to enable the flexible input and output.

The preferred embodiment of the invention relates to obtaining information in the context of a map. The principles of the invention will be discussed in the context of a person in New York City that desires to receive information about shops, restaurants, bars, museums, tourist attractions, etc. In fact, the approach applies to any entities located on a map. Furthermore, the approach extends to other kinds of complex visual displays. For example, the entities could be components on a circuit diagram. The response from the system typically involves a graphical presentation of information on a map and synthesized speech. As can be understood, the principles set forth herein will be applied to any number of user interactions and is not limited to the specific examples provided.

An example of the invention is applied in a software application called Multi-modal Access To City Help (“MATCH”). MATCH enables the flexible user interface for the user to obtain desired information. As shown in FIG. 5, the multi-modal architecture 50 that supports MATCH comprises a series of agents that communicate through a facilitator MCUBE 52. The MCUBE 52 is preferably a Java-based facilitator that enables agents to pass messages either to single agents or to a group of agents. It serves a similar function to systems such as Open Agent Architecture (“OAA”) (see, e.g., Martin, Cheyer, Moran, “The Open Agent Architecture: A Framework for Building Distributed Software Systems”, Applied Artificial Intelligence (1999)) and the user of KQML for messaging discussed in the literature. See, e.g., Allen, Dzikovska, Ferguson, Galescue, Stent, “An Architecture for a Generic Dialogue Shell”, Natural Language Engineering, (2000). Agents may reside either on the client device or elsewhere on a land-line or wireless network and can be implemented in multiple different languages. The MCUBE 52 messages are encoded in XML, which provides a general mechanism for message parsing and facilitates logging of multi-modal exchanges.

The first module or agent is the multi-modal user interface (UI) 54 that interacts with users. The UI 54 is browser-based and runs, for example, in Internet Explorer. The UI 54 facilitates rapid prototyping, authoring and reuse of the system for different applications since anything that can appear on a webpage, such as dynamic HTML, ActiveX controls, etc., can be used in the visual component of a multi-modal user interface. A TCP/IP control enables communication with the MCUBE 52.

For the MATCH example, the system 50 utilizes a control that provides a dynamic pan-able, zoomable map display. This control is augmented with ink handling capability. This enables use of both pen-based interaction on the map and normal GUI interaction on the rest of the page, without requiring the user to overtly switch modes. When the user draws on the map, the system captures his or her ink and determines any potentially selected objects, such as currently displayed restaurants or subway stations. The electronic ink is broken into a lattice of strokes and passed to the gesture recognition module 56 and handwriting recognition module 58 for analysis. When the results are returned, the system combines them and the selection information into a lattice representing all of the possible interpretations of the user's ink.

In order to provide spoken input, the user may preferably hit a click-to-speak button on the UI 54. This activates the speech manager 80 described below. Using this click-to-speak option is preferable in an application like MATCH to preclude the system from interpreting spurious speech results in noisy environments that disrupt unimodal pen commands.

In addition to providing input capabilities, the multi-modal UI 54 also provides the graphical output capabilities of the system and coordinates these with text-to-speech output. For example, when a request to display restaurants is received, the XML listing of restaurants is essentially rendered using two style sheets, yielding a dynamic HTML listing on one portion of the screen and a map display of restaurant locations on another part of the screen. In another example, when the user requests the phone numbers of a set of restaurants and the request is received from the multi-modal generator 66, the UI 54 accesses the information from the restaurant database 88, then sends prompts to the TTS agent (or server) 68 and, using progress notifications received through MCUBE 52 from the TTS agent 68, displays synchronized graphical callouts highlighting the restaurants in question and presenting their names and numbers. These are placed using an intelligent label placement algorithm.

A speech manager 80 running on the device gathers audio and communicates with an automatic speech recognition (ASR) server 82 running either on the device or in the network. The recognition server 82 provides lattice output that is encoded in XML and passed to the multi-modal integrator (MMFST) 60.

Gesture and handwriting recognition agents 56, 58 are called on by the Multi-modal UI 54 to provide possible interpretations of electronic ink. Recognitions are performed both on individual strokes and combinations of strokes in the input ink lattice. For the MATCH application, the handwriting recognizer 58 supports a vocabulary of 285 words, including attributes of restaurants (e.g., ‘Chinese’, ‘cheap’) and zones and points of interest (e.g., ‘soho’, ‘empire’, ‘state’, ‘building’). The gesture recognizer 56 recognizes, for example, a set of 50 basic gestures, including lines, arrows, areas, points, and questions marks. The gesture recognizer 56 uses a variant of Rubine's classic template-based gesture recognition algorithm trained on a corpus of sample gestures. See Rubine, “Specifying Gestures by Example” Computer Graphics, pages 329-337 (1991), incorporated herein by reference. In addition to classifying gestures, the gesture recognition agent 56 also extracts features such as the base and head of arrows. Combinations of this basic set of gestures and handwritten words provide a rich visual vocabulary for multi-modal and pen-based commands.

Gesture and handwriting recognition enrich the ink lattice with possible classifications of strokes and stroke combinations, and pass it back to the multi-modal UI 54 where it is combined with selection information to yield a lattice of possible interpretations of the electronic ink. This is then passed on to MMFST 60.

The interpretations of electronic ink are encoded as symbol complexes of the following form: G FORM MEANING (NUMBER TYPE) SEM. FORM indicates the physical form of the gesture and has values such as area, point, line, arrow. MEANING indicates the meaning of that form; for example, an area can be either a loc(ation) or a sel(ection). NUMBER and TYPE indicate the number of entities in a selection (1,2,3,many) and their type (rest(aurant), theatre). SEM is a place-holder for the specific content of the gesture, such as the points that make up an area or the identifiers of objects in a selection.

When multiple selection gestures are present, the system employs an aggregation technique in order to overcome the problems with deictic plurals and numerals. See, e.g., Johnson and Bangalore, “Finite-state Methods for Multi-modal Parsing and Integration.”ESSLLI Workshop on Finite-state Methods, Helsinki, Finland (2001), and Johnston, “Deixis and Conjunction in Multi-modal Systems”, Proceedings of COLING 2000, Saarbrücken, Germany (2000), both papers incorporated herein. Aggregation augments the gesture lattice with aggregate gestures that result from combining adjacent selection gestures. This allows a deictic expression like “these three restaurants” to combine with two area gestures, one which selects one restaurant and the other two, as long as their sum is three.

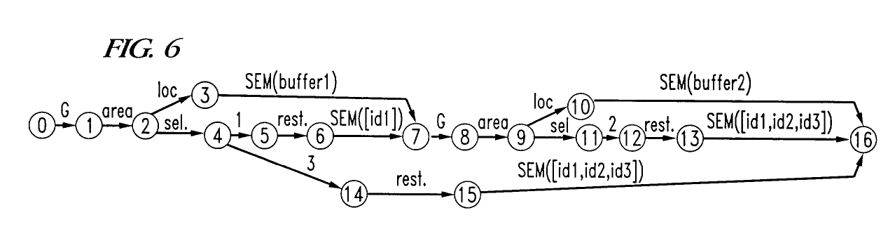

For example, if the user makes two area gestures, one around a single restaurant and the other around two restaurants, the resulting gesture lattice will be as in FIG. 6. The first gesture (node numbers 0-7) is either a reference to a location (loc.) (0-3, 7) or a reference to a restaurant (sel.) (0-2, 4-7). The second (nodes 7-13, 16) is either a reference to a location (7-10, 16) or to a set of two restaurants (7-9, 11-13, 16). The aggregation process applies to the two adjacent selections and adds a selection of three restaurants (0-2, 4, 14-16). If the user says “show Chinese restaurants in this neighborhood and this neighborhood,” the path containing the two locations (0-3, 7-10, 16) will be taken when this lattice is combined with speech in MMFST 60. If the user says “tell me about this place and these places,” then the path with the adjacent selections is taken (0-2, 4-9, 11-13, 16). If the speech is “tell me about these or phone numbers for these three restaurants,” then the aggregate path (0-2, 4, 14-16) will be chosen.

Returning to FIG. 5, the MMFST 60 receives the speech lattice (from the Speech Manager 80) and the gesture lattice (from the UI 54) and builds a meaning lattice that captures the potential joint interpretations of the speech and gesture inputs. MMFST 60 uses a system of intelligent timeouts to work out how long to wait when speech or gesture is received. These timeouts are kept very short by making them conditional on activity in the other input mode. MMFST 60 is notified when the user has hit the click-to-speak button, if used, when a speech result arrives, and whether or not the user is inking on the display. When a speech lattice arrives, if inking is in progress, MMFST 60 waits for the gesture lattice; otherwise it applies a short timeout and treats the speech as unimodal. When a gesture lattice arrives, if the user has hit click-to-speak, MMFST 60 waits for the speech result to arrive; otherwise it applies a short timeout and treats the gesture as unimodal.

MMFST 60 uses the finite-state approach to multi-modal integration and understanding discussed by Johnston and Bangalore (2000), incorporated above. In this approach, possibilities for multimodel integration and understanding are captured in a three-tape finite-state device in which the first tape represents the speech stream (words), the second the gesture stream (gesture symbols) and the third their combined meaning (meaning symbols). In essence, this device takes the speech and gesture lattices as inputs, consumes them using the first two tapes, and writes out a meaning lattice using the third tape. The three-tape FSA is simulated using two transducers: G:W which is used to align speech and gesture and G_W:M which takes a composite alphabet of speech and gesture symbols as input and outputs meaning. The gesture lattice G and speech lattice Ware composed with G:W and the result is factored into an FSA G_W which is composed with G_W:M to derive the meaning of lattice M.

In order to capture multi-modal integration using finite-state methods, it is necessary to abstract over specific aspects of gestural content. See Johnston and Bangalore (2000), incorporated above. For example, all the different possible sequences of coordinates that could occur in an area gesture cannot be encoded in the FSA. A preferred approach of using finite-state methods is the approach proposed by Johnston and Bangalore in which the gestural input lattice is converted to a transducer I:G, where G are gesture symbols (including SEM) and I contains both gesture symbols and the specific contents. I and G differ only in cases where the gesture symbol on G is SEM, in which case the corresponding I symbol is the specific interpretation. After multi-modal integration, a projection G:M is taken from the result G_W:M machine and composed with the original I:G in order to reincorporate the specific contents that had to be left out of the finite-state process (I:G₀G.M=I:M).

The multi-modal finite-state transducers used at run time are compiled from a declarative multimodal context-free grammar which captures the structure and interpretation of multi-modal and unimodal commands, approximated where necessary using standard approximation techniques. See, e.g., Nederhof, “Regular Approximations of Cfls: A Grammatical View”, Proceedings of the International Workshop on Parsing Technology, Boston, Mass. (1997). This grammar captures not just multi-modal integration patterns but also the parsing of speech and gesture and the assignment of meaning. The following paragraph presents a small fragment capable of handling MATCH commands such as “phone numbers for these three restaurants.”

| | | |
|---|---|---|
| S | → | eps:eps:<cmd> CMD eps:eps:</cmd> |
| CMD | → | phone:eps:<phone> numbers:esp:eps |
| | | for:eps:eps DEICTICNP |
| | | eps:eps:</phone> |
| DEICTINCNP | → | DDETPL eps:area:eps eps:selection:eps |
| | | NUM RESTPL eps:eps:<restaurant> |
| | | eps:SEM:SEM eps:eps:</restaurant> |
| DDETPL | → | these:G:eps |
| RESTPL | → | restaurants:restaurant:eps |
| NUM | → | three:3:eps |

A multi-modal CFG differs from a normal CFG in that the terminals are triples: W:G:M, where W is the speech stream (words), G the gesture stream (gesture symbols) and M the meaning stream (meaning symbols). An XML representation for meaning is used to facilitate parsing and logging by other system components. The meaning tape symbols concatenate to form coherent XML expressions. The epsilon symbol (eps) indicates that a stream is empty in a given terminal.

Consider the example above where the user says “phone numbers for these three restaurants” and circles two groups of the restaurants. The gesture lattice (FIG. 6) is turned into a transducer I:G with the same symbol on each side except for the SEM arcs which are split. For example, path 15-16 SEM([(id1,id2,id3]) becomes [id1,id2,id3]:SEM. After G and the speech Ware integrated using G:W and G_W:M. The G path in the result is used to reestablish the connection between SEM symbols and their specific contents in I:G (I:G₀ G:M=I:M). The meaning read off I:M is <cmd> <phone> <restaurant> [id1,id2,id3]<restaurant> <phone> </cmd>. This is passed to the multi-modal dialog manager (MDM) 62 and from there to the multi-modal UI 54 where it results in the display and coordinated TTS output on a TTS player 70. Since the speech input is a lattice and there is potential for ambiguity in the multi-modal grammar, the output from the MMFST 60 to the MDM 62 is in fact a lattice of potential meaning representations.

The general operation of the MDM 62 is known as using speech-act based models of dialog. See, e.g., Stent, Dowding, Gawron, Bratt, Moore, “The CommandTalk Spoken Dialogue System”, Proceedings of ACL '99, (1999) and Rich, Sidnes, “COLLAGEN” A Collaboration Manager for Software Interface Agents”, User Modeling and User-Adapted Interaction (1998). It uses a Java-based toolkit for writing dialog managers that embodies an approach similar to that used in TrindiKit. See, Larsson, Bohlin, Bos, Traum, Trindikit manual, TRINDI Deliverable D2.2. (1999). It includes several rule-based processes that operate on a shared state. The state includes system and user intentions and beliefs, a dialog history and focus space, and information about the speaker, the domain and the available modalities. The processes include an interpretation process, which selects the most likely interpretation of the user's input given the current state; an update process, which updates the state based on the selected interpretation; a selection process, which determines what the system's possible next moves are; and a generation process, which selects among the next moves and updates the system's model of the user's intentions as a result.

MDM 62 passes messages on to either the text planner 72 or directly back to the multi-modal UI 54, depending on whether the selected next move represents a domain-level or communication-level goal.

In a route query example, MDM 62 first receives a route query in which only the destination is specified, “How do I get to this place?” In the selection phase, the MDM 62 consults the domain model and determines that a source is also required for a route. It adds a request to query the user for the source to the system's next move. This move is selected and the generation process selects a prompt and sends it to the TTS server 68 to be presented by a TTS player 70. The system asks, for example, “Where do you want to go from?” If the user says or writes “25^{th} Street and 3^{rd} Avenue”, then MMFST 60 assigns this input two possible interpretations. Either this is a request to zoom the display to the specified location or it is an assertion of a location. Since the MDM dialogue state indicates that it is waiting for an answer of the type location, MDM reranks the assertion as the most likely interpretation for the meaning lattice. A generalized overlay process is used to take the content of the assertion (a location) and add it into the partial route request. See, e.g., Alexandersson and Becker, “Overlay as the Basic Operation for Discourse Processing in a Multi-modal Dialogue System”, 2^{nd} IJCAI Workshop on Knowledge and Reasoning in Practical Dialogue Systems (2001). If the result is complete, it is passed on to the UI 54, which resolves the location specifications to map coordinates and passes on a route request to the SUBWAY component.

In the MATCH example, a Subway Route Constraint Solver (SUBWAY) 64 has access to an exhaustive database of the NYC subway system. When it receives a route request with the desired source and destination points from the Multi-modal UI 54, it explores the search space of possible routes in order to identify the optimal route, using a cost function based on the number of transfers, overall number of stops, and the distance to walk to/from the station at each end. It builds a list of the actions required to reach the destination and passes them to the multi-modal generator 26.

The multi-modal generator 66 processes action lists from SUBWAY 24 and other components and assigns appropriate prompts for each action. The result is a ‘score’ of prompts and actions that is passed to the multi-modal UI 54. The multi-modal UI 54 plays this score by coordinating presentation of the graphical consequences of actions with the corresponding TTS prompts.

The system 50 includes a text-to-speech engine, such as AT&T's next generation text-to-speech engine, that provides spoken output of restaurant information such as addresses and reviews, and for subway directions. The TTS agent 68, 70 provides progress notifications that are used by the multi-modal UI 54 to coordinate speech with graphical displays. A text planner 72 and user model or profile 74 receive instructions from the MDM 62 for executing commands such as “compare”, “summarize” and “recommend.” The text planner 72 and user model 74 components enable the system to provide information such as making a comparison between two restaurants or musicals, summarizing the menu of a restaurant, etc.

A multi-modal logger module 76 enables user studies, multi-modal data collection, and debugging. The MATCH agents are instrumented so that they send details of user inputs, system outputs, and results of intermediate stages to a logger agent that records them in an XML log format devised for multi-modal interactions. A multi-modal XML log 78 is thus developed. Importantly, the system 50 collects data continually through system development and also in mobile settings. Logging includes the capability of high fidelity playback of multi-modal interaction. Along with the user's ink, the system also logs the current state of the UI 54 and the multi-modal UI 54 can dynamically replay user's speech and ink as they were received and show how the system responded. The browser- and component-based nature of the multi-modal UI 54 make it straightforward to reuse it to build a Log Viewer that can run over multi-modal log files, replay interactions between the user and system, and allow analysis and annotation of the data.

The system 50 logging capability is related in function to STAMP but does not require multi-modal interactions to be videotaped. See, e.g., Oviatt and Clow, “An Automated Tool for Analysis of Multi-modal System Performance”, Proceedings of the International Conference on Spoken Language Processing, (1998). The ability of the system to run standalone is an important design feature since it enables testing and collection of multi-modal data in realistic mobile environments without relying on the availability of a wireless network.

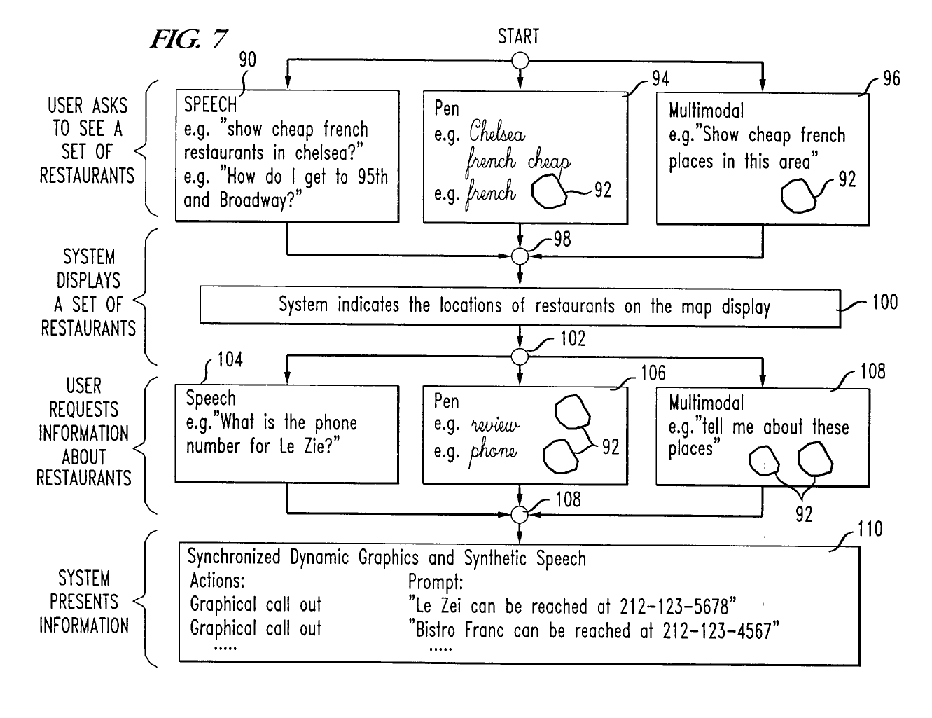

FIG. 7 illustrates the process flow for a user query to the system regarding restaurants. At a beginning time in a dialogue with the system, the user can input data in a plurality of different ways. For example, using speech only 90, the user can request information such as “show cheap French restaurants in Chelsea” or “how do I get to 95 street and broadway?” Other modes of input include pen input only, such as “chelsea french cheap,” or a combination of pen “French” and a gesture 92 on the screen 94. The gestures 92 represent a circling gesture or other gesture on the touch sensitive display screen. Yet another flexible option for the user is to combine speech and gestures 96. Other variations may also be included beyond these examples.

The system processes and interprets the various kinds of input 98 and provides an output that may also be unimodal or multi-modal. If the user requests to see all the cheap French restaurants in Chelsea, the system would then present on the screen the cheap French restaurants in Chelsea 100. At which point 102, the system is ready to receive a second query from the user based on the information being currently displayed.

The user again can take advantage of the flexible input opportunities. Suppose the user desires to receive a phone number or review for one of the restaurants. In one mode, the user can simply ask “what is the phone number for Le Zie?” 104 or the user can combine handwriting, such as “review” or “phone” with a gesture 92 circling Le Zie on the touch sensitive screen 106. Yet another approach can combine speech, such as “tell me about these places” and gestures 92 circling two of the restaurants on the screen 108. The system processes the user input 108 and presents the answer either in a unimodal or multi-modal means 110.

Table 1 illustrates an example of the steps taken by the system for presenting multi-modal information to the user as introduced in box 110 of FIG. 7.

TABLE 1

| Graphics | Speech from the System |
|---|---|
| <draw graphical callout indicating | Le Zie can be reached at |
| restaurant and information> | 212-567-7896 |
| <draw graphical callout indicating | Bistro Frank can be reached at |
| restaurant and information> | 212-777-7890 |

As a further example, assume that the second request from the user asks for the phone number of Le Zie, the system may zoom in on Le Zie and provide synthetic speech stating “Le Zie can be reached at 212-123-5678”. In addition to the zoom out and speech, the system may also present graphically the phone number on the screen or other presentation field.

In this manner, the present invention makes the human computer interaction much more flexible and efficient by enabling the combination of inputs that would otherwise be much more cumbersome in a single mode of interaction, such as voice only.

As an example of the invention, assume a user desires to know where the closest French restaurants are and the user is in New York City. A computer device storing a computer program that operates according to the present invention can render a map on the computer device. The present invention enables the user to use both speech input and pen “ink” writing on the touch-sensitive screen of the computer device. The user can ask (1) “show cheap French restaurants in Chelsea”, (2) write on the screen: “Chelsea French cheap” or (3) say “show cheap French places here” and circle on the map the Chelsea area. In this regard, the flexibility of the service enables the user to use any combination of input to request the information about French restaurants in Chelsea. In response to the user request, the system typically will present data to the user. In this example, the system presents on the map display the French restaurants in Chelsea. Synthetic speech commentary may accompany this presentation. Next, once the system presents this initial set of information to the user, the user will likely request further information, such as a review. For example, assume that the restaurant “Le Zie” is included in the presentation. The user can say “what is the phone number for Le Zie?” or write “review” and circle the restaurant with a gesture, or write “phone” and circle the restaurant, or say “tell me about these places” and circle two restaurants. In this manner, the flexibility of the user interface with the computer device is more efficient and enjoyable for the user.

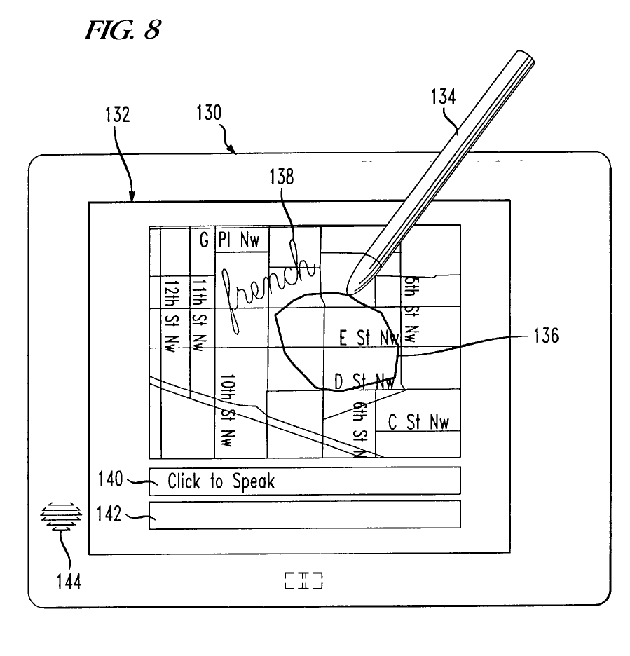

FIG. 8 illustrates a screen 132 on a computer device 130 for illustrating the flexible interaction with the device 130. The device 130 includes a microphone 144 to receive speech input from the user. An optional click-to-speak button 140 may be used for the user to indicate when he or she is about to provide speech input. This may also be implemented in other ways such as the user stating “computer” and the device 130 indicating that it understands either via a TTS response or graphical means that it is ready to receive speech. This could also be implemented with an open microphone which is always listening and performs recognition based on the presence of speech energy. A text input/output field 142 can provide input or output for the user when text is being interpreted from user speech or when the device 130 is providing responses to questions such as phone numbers. In this manner, when the device 130 is presenting synthetic speech to the user in response to a question, corresponding text may be provided in the text field 142.

A pen 134 enables the user to provide handwriting 138 or gestures 136 on the touch-sensitive screen 132. FIG. 8 illustrates the user inputting “French” 138 and circling an area 136 on the map. This illustrates the input mode 94 discussed above in FIG. 7.

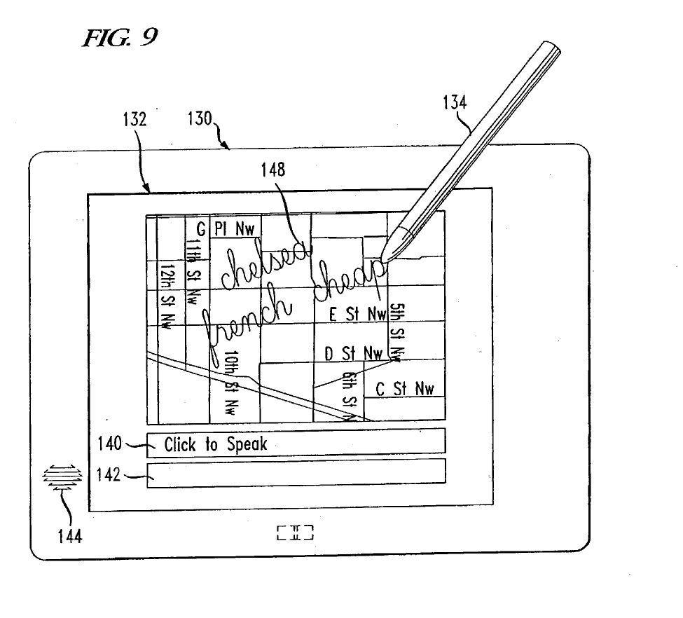

FIG. 9 illustrates a text or handwriting-only input mode in which the user writes “Chelsea French cheap” 148 with the pen 134 on the touch-sensitive screen 132.

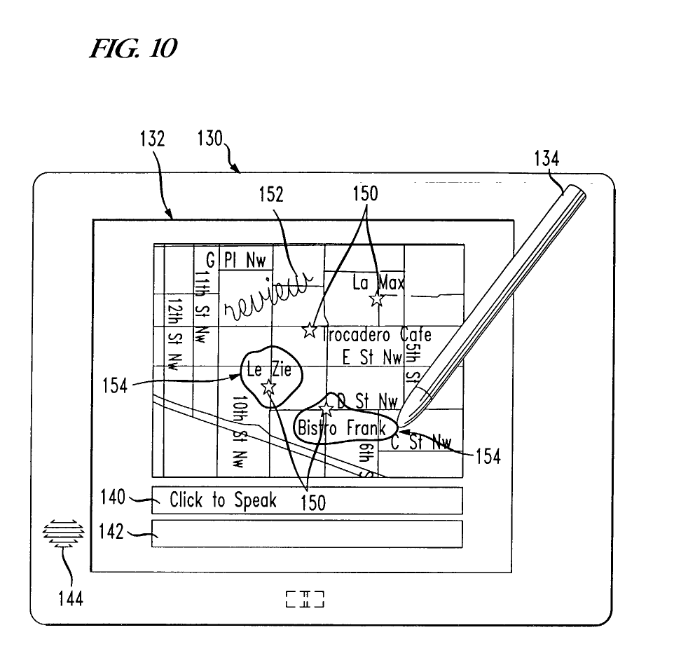

FIG. 10 illustrates a response to the inquiry “show the cheap french restaurants in Chelsea.” In this case, on the map within the screen 132, the device displays four restaurants 150 and their names. With the restaurants shown on the screen 132, the device is prepared to receive further unimodal or multi-modal input from the user. If the user desires to receive a review of two of the restaurants, the user can handwrite “review” 152 on the screen 132 and gesture 154 with the pen 134 to circle the two restaurants. This illustrates step 106 shown in FIG. 7. In this manner, the user can efficiently and quickly request the further information.

The system can then respond with a review of the two restaurants in either a uni-modal fashion like presenting text on the screen or a combination of synthetic speech, graphics, and text in the text field 142.

The MATCH application uses finite-state methods for multi-modal language understanding to enable users to interact using pen handwriting, speech, pen gestures, or any combination of these inputs to communicate with the computer device. The particular details regarding the processing of multi-modal input are not provided in further detail herein in that they are described in other publications, such as, e.g., Michael Johnston and Srinivas Bangalore, “Finite-state multi-modal parsing and understanding,” Proceedings of COLING 2000, Saarbruecken, Germany and Michael Johnston, “Unification-based multi-modal parsing,” Proceedings of COLING-ACL, pages 624-630, Montreal, Canada. The contents of these publications are incorporated herein by reference.

The benefits of the present invention lie in the flexibility it provides to users in specifying a query. The user can specify the target destination and a starting point using spoken commands, pen commands (drawing on the display), handwritten words, or multi-modal combinations of the two. An important aspect of the invention is the degree of flexibility available to the user when providing input. Once the system is aware of the user's desired starting point and destination, it uses a constraint solver in order to determine the optimal subway route and present it to the user. The directions are presented to the user multi-modally as a coordinated sequence of graphical actions on the display with coordinated prompts.

In addition to the examples above, a GPS location system would further simplify the interaction when the current location of the user needs to be known. In this case, when the user queries how to get to a destination such as a restaurant, the default mode is to assume that the user wants to know how to get to the destination from the user's current location as indicated by the GPS data.

As mentioned above, the basic multi-modal input principles can be applied to any task associated with the computer-user interface. Therefore, whether the user is asking for directions or any other kind of information such as news, weather, stock quotes, or restaurant information and location, these principles can apply to shorten the number of steps necessary in order to get the requested information.

Although the above description may contain specific details, they should not be construed as limiting the claims in any way. Other configurations of the described embodiments of the invention are part of the scope of this invention. For example, any interaction between a computer and a user can take place in a flexible multi-modal fashion as described above. The core principles of the invention do not relate to providing information regarding restaurant review but rather the flexible and efficient steps and interactions between the user and the computer. Accordingly, the appended claims and their legal equivalents should only define the invention, rather than any specific examples given.

We claim:

1. A method of interacting with a user on a computer device, the computer device being capable of receiving a plurality of types of user input and being capable of presenting information in a plurality of types of device output, the method comprising:
(1) receiving a user query in one of the plurality of types of user input;
(2) presenting data to the user related to the user query;
(3) receiving a second user query associated with the presented data in one of the plurality of types of user input; and
(4) presenting a response to the user query or the second user query.

2. The method of claim 1, wherein the plurality of types of user input comprises user input via speech, pen, and multi-modally.

3. The method of claim 1, wherein the plurality of types of user input comprises speech, text-based pen graphics, and a combination of speech and gestures.

4. The method of claim 2, wherein the plurality of types of device output comprises synthesized speech, graphics and a combination of speech and graphics.

5. The method of claim 2, wherein multi-modally comprises a combination of speech and gestures.

6. The method of claim 1, wherein one of the plurality of types of user input comprises speech and gestures.

7. The method of claim 1, wherein the user query relates to a request for a set of businesses within an area.

8. The method of claim 7, wherein presenting data to the user related to the user query further comprises presenting a graphical presentation of the set of businesses within the area.

9. The method of claim 8, wherein the set of businesses are restaurants.

10. The method of claim 8, wherein the set of businesses are retail stores.

11. The method of claim 8, wherein the set of businesses are tourist sites.

12. The method of claim 8, wherein the set of businesses are theatres.

13. The method of claim 12, where in the set of businesses are movie theatres.

14. A method of providing information associated with a map to a user via interaction with a computer device, the computer device being capable of receiving a plurality of types of user input comprising speech, pen or multi-modally, the method comprising:
(1) receiving a user query in speech, pen or multi-modally;
(2) presenting data to the user related to the user query;
(3) receiving a second user query associated with the presented data in one of the plurality of types of user input; and
(4) presenting a response to the user query or the second user query.

15. The method of claim 14, where multi-modally comprises a combination of speech and gestures.

16. The method of claim 14, wherein the response to the user query or the second user query comprises a combination of speech and graphics.

17. The method of claim 14, wherein multi-modally includes a combination of speech and handwriting.

18. The method of claim 14, wherein the user query relates to a request for a set of businesses within an area.

19. The method of claim 14, wherein presenting data to the user related to the user query further comprises presenting a graphical presentation of a set of businesses within the area.

20. The method of claim 19, wherein the set of businesses are restaurants.

21. The method of claim 19, wherein the set of businesses are retail stores.

22. The method of claim 19, wherein the set of businesses are tourist sites.

23. The method of claim 19, wherein the set of business are theaters.

24. The method of claim 23, wherein the set of businesses are movie theaters.

25. A method of providing information to a user via interaction with a computer device, the computer device being capable of receiving user input via speech, pen or multi-modally, the method comprising:
(1) receiving a user business entity query in speech, pen or multi-modally, the user business entity query including a query related to a business location; and
(2) presenting a response to the user business entity query.

26. The method of claim 25, further comprising, after presenting a response to the user business entity query:
(3) receiving a second user query related to the presented response; and
(4) presenting a second response addressing the second user query.

27. The method of claim 25, wherein multi-modally comprises a combination of speech and gestures.

28. The method of claim 25, wherein multi-modally comprises a combination of speech and handwriting.

29. The method of claim 25, wherein presenting a response to the user business entity query further comprises:
graphically illustrating information associated with the user business query; and
presenting synthetic speech providing information regarding the graphical information.

30. The method of claim 26, wherein presenting a second response addressing the second user query further comprises:
graphically illustrating second information associated with the second user query; and
presenting synthetic speech providing information regarding the graphical second information.

31. The method of claim 25, wherein the business entity is a restaurant.

32. The method of claim 25, wherein the business entity is a retail shop.

33. The method of claim 25, wherein the business entity is a tourist site.

34. A method of providing business-related information to a user on a computer device, the computer device being capable of receiving input either via speech, pen, or multi-modally, the method comprising:
(1) receiving a user query regarding a business either via speech, pen or multi-modally, the user query including a location component; and
(2) in response to the user query, presenting on a map display information associated with the user query.

35. The method of claim 34, further comprising, after presenting on a map display information associated with the user query:
(3) receiving a second user query associated with the displayed information;
(4) in response to the second user query, presenting on the map display information associated with the second user query.

36. The method of claim 34, further comprising:
providing synthetic speech associated with the information presented on the map display in response to the user query.

37. The method of claim 35, further comprising:
providing synthetic speech associated with the information presented on the map display in response to the second user query.

38. An apparatus for interacting with a user, the apparatus storing a multi-modal recognition module using a finite-state machine to build a single meaning representation from a plurality of types of user input, the apparatus comprising:
(1) means for receiving a user query in one of the plurality of types of user input;
(2) means for presenting information on a map display related to the user query;
(3) means for receiving further user input in one of the plurality of types of user input; and
(4) means for presenting a response to the user query.

39. An apparatus for receiving multi-modal input from a user, the apparatus comprising:
a user interface module;
a speech recognition module;
a gesture recognition module;
an integrator module;
a facilitator module that communicates with the user interface module, the speech recognition module, the gesture recognition module and the integrator module, wherein the apparatus receives user input as speech through the speech recognition module, gestures through the gesture recognition module, or a combination of speech and gestures through the integrator module, processes the user input, and generates a response to the user input through the facilitator module and the user interface module.
